(19) United States
(12) Patent Application Publication
(10) Pub. No.: US 2001/0014927 A1
(43) Pub. Date: Aug. 16, 2001

(54) Dual interface card and socket

(76) Inventors: Tsung-Yen Dean Chang, Los Altos Hills, CA (US); Chuang Li, Saratoga, CA (US)

Correspondence Address: FISH & NEAVE, 1251 AVENUE OF THE AMERICAS, 50TH FLOOR, NEW YORK, NY, 10020-1105, US

(21) Appl. No.: 09/842,327

(22) Filed: Apr. 24, 2001

Related U.S. Application Data
(63) Continuation of application No. 09/173,707, filed on Oct. 15, 1998, now abandoned.

(51) Int. Cl. G06F 13/00

(52) U.S. Cl. 710/102

(57) ABSTRACT

A combination audio, modem, and network interface card for use with a personal computer is described. The card has a standard Audio/Modem Riser (AMR) edge connector for providing signals to the audio and modem portions of the card. A second edge connector, preferably conforming to the PCI specification, provides signals to the network interface portion of the card. A socket through which the card may be plugged into a motherboard is also described. The socket has an AMR portion, positioned so that it can accept a either a standard AMR card or the AMR edge connector of the combination card, and a PCI portion, that permits it to receive the second edge connector of the combination card.

### FIELD OF THE INVENTION

The present invention relates generally to a plug-in card for use with a personal computer, the card having connectors conforming to two different interface standards. More specifically, the invention relates to a card having both AMR and PCI connectors, and to a specialized socket for receiving the card.

### BACKGROUND OF THE INVENTION

Over the past few years, the speed of the microprocessors used in personal computers has increased dramatically. Processors having clock speeds of 300 MHz and higher are commonplace, and even faster processors are being released every few months. At the same time that the speed of processors is increasing, the price for high-speed processors is falling rapidly. Due in part to the widespread availability of inexpensive, high-performance microprocessors, many personal computer manufactures are now offering computer systems priced as low as $500, and during the past year, personal computer systems priced at under $1000 were the fastest growing segment of the personal computer market.

Although they are inexpensive, these sub-$1000 computer systems have a range of communications and multimedia capabilities, making them attractive to home users. A typical sub-$1000 computer system includes (among other features) a high-speed modem for connecting the computer to the Internet, and a sound card, for generating high-quality music and sound effects.

The decreasing price of personal computers is driving manufacturers to seek ways of integrating functionality to save manufacturing costs. Integrating common functionality, such as the modem and audio subsystems onto the motherboard, for example, may decrease overall system cost. Additionally, it has been observed that audio and modem functions require relatively little processing, due to their low speed. For example, it requires only a small portion of the available computing power of a processor that is running at a clock speed of more than 300 MHz to produce high-quality audio at 44 KHz. Using the processor to perform many of the functions that are currently performed by modems and sound cards further reduces the cost of the computer system, and increases the flexibility of both the modem and audio subsystems.

In addition to the digital processing of audio and modem signals, that may be performed by the processor or other digital circuitry, both the audio and modem subsystems have an analog portion. Typically, this involves the use of a codec (coder/decoder), to convert between digital signals and analog audio or telephone signals, and may include the use of other analog components, such as amplifiers and filters. These analog functions cannot be performed by inexpensive computer systems include a network a typical microprocessor, and generally require the use of specialized analog hardware.

Integrating the audio and modem codecs and other analog hardware onto the motherboard of a personal computer has proven to be problematic. For example, if the analog portion of the modem circuitry is integrated onto a motherboard, then the market introduction of the motherboard may be delayed while the analog modem circuitry undergoes certification by the FCC, and by other international telecommunications regulatory agencies. Additionally, poor signal isolation has caused difficulties in integrating the analog portions of the audio subsystem onto personal computer motherboards.

To address these issues, Intel Corporation, of Santa Clara, Calif., has introduced the Audio/Modem Riser specification. Revision 1.01 of this specification, which was published by Intel on Sep. 10, 1998, as “Audio/Modem Riser Specification,” is incorporated herein by reference. The specification describes a motherboard riser card, a connector and socket for connecting the card to the motherboard, and an interface through which signals may be sent from the motherboard to the card. The card contains the analog portion of the modem and/or audio subsystems of the computer, including a primary codec, and up to three secondary codecs. Additionally, the Audio/Modem Riser (AMR) Specification describes a serial digital interface, through which digital audio or modem signals may be sent to the codecs and other circuitry on the card.

Unfortunately, the AMR specification fails to take networking into consideration. Increasingly, inexpensive computer systems include a network interface, to permit such computers to be connected to a local area network (LAN). As network hardware decreases in price, and increasing numbers of inexpensive computers and peripherals include network support, installation of LANS in homes and small offices will become commonplace.

Already, many manufacturers are preparing for the advent of widespread home LAN use, by developing technologies that make it easy to install a LAN in a home environment. These include technologies that can connect a LAN through preexisting wiring in a home, for example, by sending LAN traffic across power lines or home telephone lines. Also, numerous wireless LAN technologies that may be appropriate for home use have been developed, such as infrared and low-power RF LANs.

These networking functions are typically performed by a plug-in network interface card, that includes appropriate network connectors, and circuitry for sending data across a network, and for receiving data from a network. Installation of a network interface card typically takes up one of the expansion slots of a computer, such as a PCI or ISA slot. Additionally, it may be awkward to connect a network interface card that, for example, connects to a home phone line, along with a modem that also connects to the home phone line. Integration of networking functionality with modem and/or audio functionality may decrease the cost of computers that include audio capabilities, a modem, and a network interface, and provide enhanced ease of use and installation.

Although combining networking capabilities onto an AMR card that contains the analog portions of the analog modem and audio circuitry would address these issues, the AMR specification does not support such a configuration. Specifically, the AMR interface does not include the signals that are needed by a typical network interface. Furthermore, the connector and socket defined in the AMR standard do not have enough spare connections to handle the functions of a typical network interface. Although the AMR interface specification includes optional signal paths for a Universal Serial Bus (USB) connection, such a connection is not sufficient to support most modern networking needs.

In view of the above, it would be desirable to provide a plug-in card that combines an AMR modem and audio card with a network interface card.

It would also be desirable to provide a socket for a combination audio, modem, and network card, wherein the socket includes a portion conforming to the AMR specification, so that the socket may optionally receive a standard AMR card.

### SUMMARY OF THE INVENTION

It is an object of the present invention to provide a plug-in card that combines an AMR modem and audio card with a network interface card.

It is also an object of the invention to provide a socket for receiving a combination audio, modem, and network card, wherein the socket includes a portion conforming to the AMR specification, so that the socket may optionally receive a standard AMR card.

These and other objects of the invention are achieved by providing a plug-in card having audio and modem codecs, network interface circuitry, and two edge connectors. The first edge connector conforms to the AMR specification, and transfers serial digital signals between a computer motherboard and the audio and modem codecs. The second edge connector permits the transfer of data needed by the network interface circuitry. In a preferred embodiment, the second edge connector substantially conforms to the PCI specification.

The edge connectors are arranged linearly, so that a socket on the motherboard that receives the card has an AMR portion, that receives the AMR edge connector, arranged in-line with a PCI portion, that receives the PCI edge connector. In a preferred embodiment, the socket is disposed so that a standard AMR card may be connected to the motherboard using only the AMR portion of the socket.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 shows a previously known AMR audio and modem card, and a motherboard with an AMR socket;

FIG. 2 shows a combined audio, modem, and network card built in accordance with the principles of the present invention, and a motherboard that includes a socket for receiving the card;

FIG. 3 shows a motherboard having a socket built in accordance with the principles of the present invention; and

FIG. 4 is another view of a combined audio, modem, and network interface card built in accordance with the principles of the present invention.

### DETAILED DESCRIPTION OF THE INVENTION

Referring to FIG. 1, a previously-known AMR audio/modem card and a motherbbard socket for receiving the card are described. AMR card 10 includes AMR edge connector 12, codec circuitry 14, and metal bracket 16. Codec circuitry 14 may include either audio codec circuitry, modem codec circuitry, or both audio and modem codec circuitry. For the purpose of illustration, hereinafter codec 14 will be assumed to include both modem and audio codec circuitry. Telephone line connector 18, telephone set connector 20, audio microphone connector 22, audio-in connector 24, and audio-out connector 26 are arranged on metal bracket 16, so that they are accessible from outside of a case (not shown) that encloses the computer system. Motherboard 28 includes PCI sockets 29, as well as AMR socket 27, that receives AMR edge connector 12.

Telephone line connector 18 and telephone set connector 20 typically comprise standard RJ-11 modular sockets. Audio microphone connector 22, audio-in connector 24, and audio-out connector 26 typically comprise standard stereo mini-plug sockets.

In use, AMR card 10 is plugged into AMR socket 27, establishing connections between motherboard 28 and AMR card 10 for numerous signals. As described in complete detail in the AMR specification, these signals include serial digital signals suitable for providing high-quality audio input and output, and for providing high speed (e.g. 56K bits per second) modem input and output. Additionally, the signals include an input and an output path for monaural audio for use in implementing speakerphone functions, generating a system “beep” sound, and for monitoring the progress of a modem connection on systems where the AMR card does not include audio functions. The signals also include a variety of optional audio control and Universal Serial Bus (USB) signals, as well as a few signals that are reserved for future use.

Serial digital signals generated by digital audio or modem components (not shown), or by the processor (not shown) on motherboard 28 are passed as signals to codec circuitry 14, which converts the signals to an appropriate analog form, and sends analog modem signals out through telephone line connector 18 and telephone set connector 20, and audio signals out through audio-out connector 26. Similarly, analog audio signals received through microphone connector 22 or audio-in connector 24, and analog modem signals received through telephone line connector 18 or telephone set connector 20 are converted to digital signals by codec circuitry 14, and are sent as serial digital signals to digital circuitry on motherboard 28 for further processing. To perform these functions, circuitry 14 typically includes a variety of analog components, such as amplifiers, filters, and modem DAA circuitry.

By using an AMR card, such as is shown in FIG. 1, to handle (at least) the analog portion of the modem and audio subsystems, system manufacturers can achieve lower costs through greater integration of features, while still gaining the benefits of placing certain portions of the audio and modem subsystems on a removable card. For example, decoupling the analog portions of the modem subsystem from the motherboard through use of an AMR card helps avoids delays in the release of motherboards due to certification by the FCC and by other international telecommunications regulatory agencies. Decoupling the analog portions of he audio circuitry from the motherboard also helps to achieve improved audio performance.

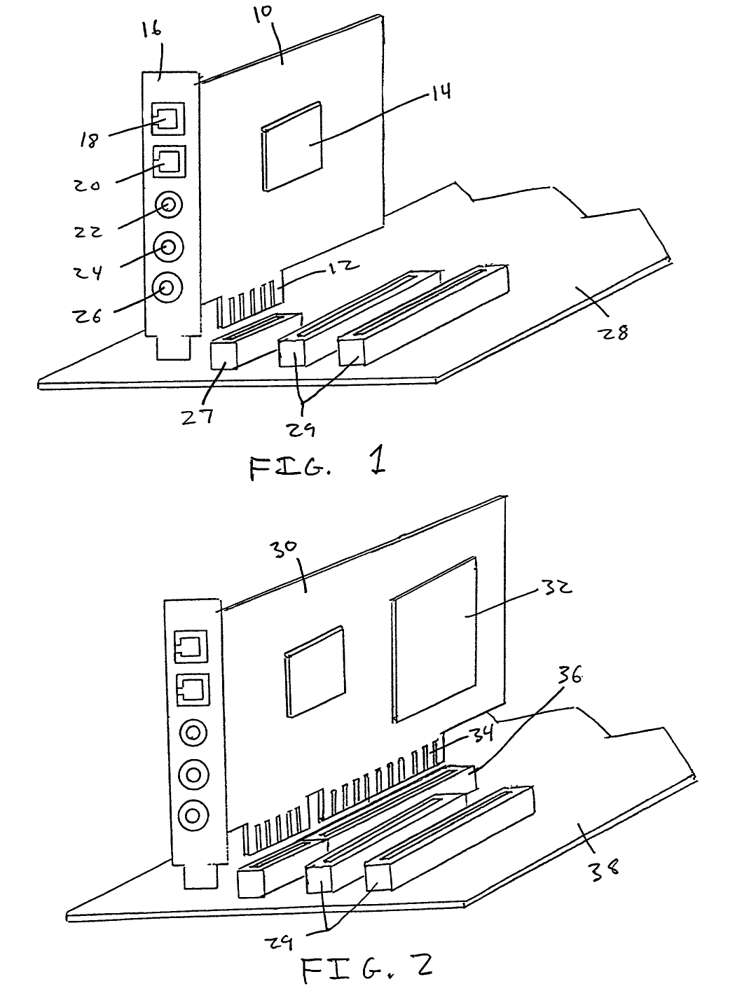

Referring now to FIG. 2, a combined audio, modem, and network interface card built in accordance with the principles of the present invention is described. As can be seen in FIG. 2, card 30 is similar to AMR card 10 of FIG. 1. Card 30, however, also comprises network interface circuitry 32, and second edge connector 34, as described in greater detail hereinbelow. As is also evident from FIG. 2, socket 36 is specially designed to receive the two edge connectors of card 30, and connect card 30 to motherboard 38.

FIG. 3 shows a more detailed view of socket 36, built in accordance with the principles of the present invention. Socket 36 comprises two portions. AMR portion 40 of socket 36 conforms to the standards set out in the AMR specification, and is substantially identical to AMR socket 27 of FIG. 1. PCI portion 42 of socket 36 conforms to a specification of the PCI interface, and is substantially identical to PCI sockets 29. The two portions of socket 36 have a linear arrangement, so that AMR portion 40 is in-line with PCI portion 42. Advantageously, this linear arrangement takes up relatively little extra space on motherboard 38, and does not interfere with the spacing of other PCI sockets 29 on motherboard 38.

When card 30 is plugged into socket 36, serial digital signals, for use by the audio and modem subsystems are passed through AMR portion 40. AMR portion 40 also provides access to other AMR signals, such as the monaural audio, and optional USB and control signals described hereinabove.

Because the signals provided by AMR portion 40 are not sufficient to provide for a modern network interface, PCI portion 42 provides signals for use by network interface circuitry 32. Since PCI portion 42 conforms to a specification of the PCI interface, the amount of circuitry that must be added to motherboard 38 to handle the signals that are passed through PCI portion 42 is minimal, and the data rate and available signals for PCI portion 42 are more than sufficient to handle most networking requirements.

In a preferred embodiment, AMR portion 40 is positioned on motherboard 38 so that it can accept a standard AMR card. Advantageously, this permits computers that do not require networking capabilities to use a standard AMR card in socket 36, while computers that need networking can use card 30, which includes the usual modem and audio capabilities of an AMR card, as well as the networking capabilities of a PCI network interface card.

It will be understood by one skilled in the art that PCI portion 42 of socket 36 may be replaced with a portion conforming to an interface specification other than PCI, such as ISA, or a custom motherboard interface specification. Of course, to support such modifications, the edge connectors of card 30 must match socket 36, and motherboard 38 must handle the signals for the chosen motherboard interface.

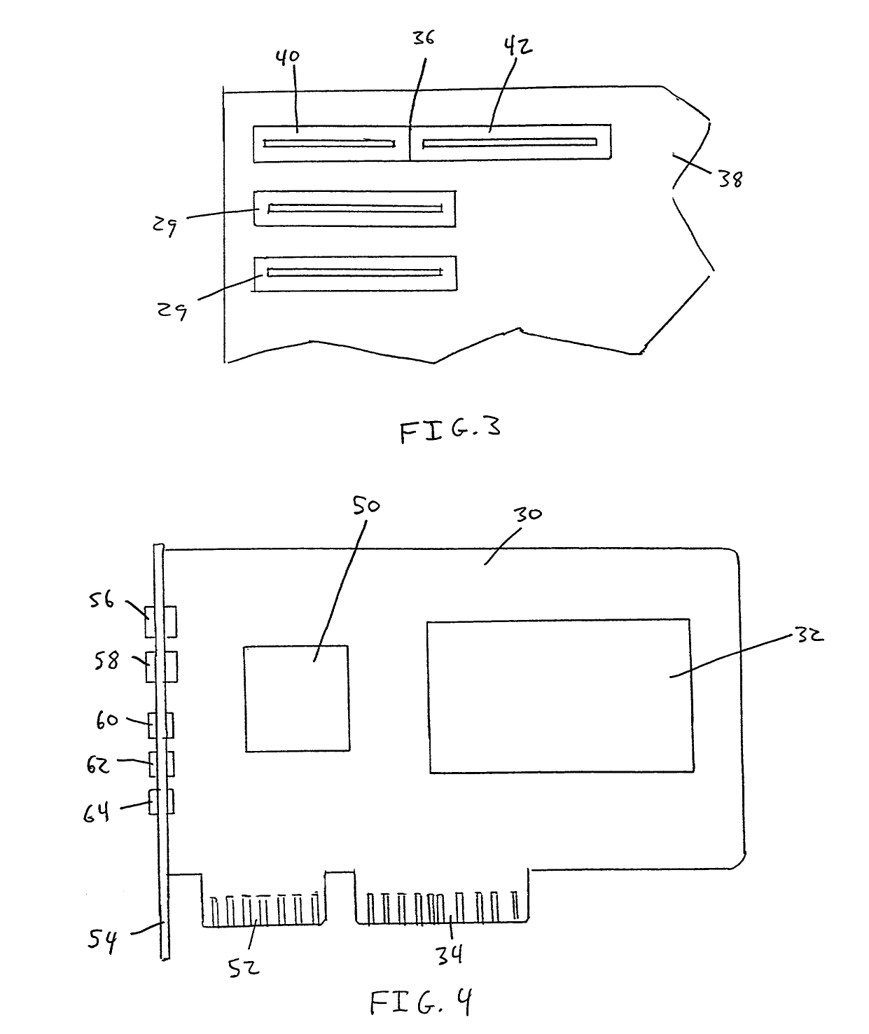

Referring now to FIG. 4, card 30 is described in detail. Card 30 comprises network interface circuitry 32, codec circuitry 50, AMR edge connector 52, second edge connector 34, and metal bracket 54. Metal bracket 54 includes telephone line connector 56, telephone set connector 58, audio microphone connector 60, audio-in connector 62, and audio-out connector 64. These connectors are arranged on metal bracket 16, so that they are accessible from outside of a case (not shown) that encloses the computer system.

Codec circuitry 50, AMR edge connector 52, telephone line connector 56, telephone set connector 58 audio microphone connector 60, audio-in connector 62, and audio-out connector 64 are substantially identical to codec circuitry 14, AMR edge connector 12, telephone line connector 18, telephone set connector 20, audio microphone connector 22, audio-in connector 24, and audio-out connector 26, respectively, as described hereinabove with reference to FIG. 1.

Network interface circuitry 32 preferably comprises circuitry for sending network traffic across a standard home telephone line. In such a preferred embodiment, telephone line connector 56 and telephone set connector 58 provide simultaneously for modem communications, and for handling network traffic. The user need only plug in a single standard telephone line to be connected to a home LAN, through network interface circuitry 32, and to a public telephone network, through codec circuitry 50.

It will be understood by one skilled in the art that network interface circuitry 32 may comprise any standard network interface circuitry. If the network interface circuitry does not communicate with the network through telephone lines, it may be necessary to add an additional connector to metal bracket 54. For example, if 10Base-T Ethernet is used, metal bracket 54 should include an RJ-45 socket (not shown) for connecting to the LAN.

Because AMR edge connector-52 does not provide the signals that are needed by network interface circuitry 32, card 30 includes second edge connector 34, in accordance with the principles of the present invention. In a preferred embodiment, second edge connector 34 conforms with a specification of the PCI interface, thereby providing ample data throughput and signal availability for most networking functions. Advantageously, if second edge connector 34 conforms to a specification of the PCI interface, network interface circuitry 32 may comprise standard PCI network interface circuitry. Such circuitry is readily available in a variety of forms, and is relatively inexpensive.

In operation, when card 30 is plugged into socket 36, codec circuitry 50 handles serial digital data through AMR edge connector 52. Simultaneously, network interface circuitry 32 communicates with motherboard 38 through second edge connector 34, and handles LAN traffic. In a preferred embodiment, the network interface functions of card 30 appear to the computer system to be no different than the network interface functions performed by any PCI network interface card.

It will be understood by one skilled in the art that other communications technologies may also be added to card 30. For example, circuitry for handling digital subscriber line communications (xDSL—i.e. ADSL, HDSL, SDSL, VDSL, etc.) may be added to card 30, or may replace other modem functions.

Although preferred illustrative embodiments of the present invention are described above, it will be evident to one skilled in the art that various changes and modifications may be made without departing from the invention. For example, it would be possible to use the second edge connector and in-line socket design of the present invention to combine the audio and modem functionality of an AMR card with functions other than networking, such as enhanced multimedia or video. Additionally, second edge connector 34 and PCI portion 42 of socket 36 need not conform to a specification of the PCI interface—use of other interface standards, such as ISA, is possible. It is intended in the appended claims to cover all such changes and modifications that fall within the true spirit and scope of the invention.

What is claimed is:

1. A plug-in card for use with a personal computer, the card comprising:
an AMR edge connector conforming to a specification of the Audio/Modem Riser interface;
a second edge connector;
codec circuitry coupled to the AMR edge connector; and
second circuitry coupled to the second edge connector.

2. The plug-in card of claim 1, wherein the codec circuitry comprises an audio codec.

3. The plug-in card of claim 1, wherein the codec circuitry comprises a modem codec.

4. The plug-in card of claim 1, wherein the plug-in card further comprises circuitry for handling xDSL communications.

5. The plug-in card of claim 1, wherein the second circuitry comprises network interface circuitry.

6. The plug-in card of claim 51, wherein the plug-in card further comprises a bracket including a telephone line connector, and wherein the network interface circuitry uses the telephone line connector to send and receive network traffic through a home telephone line.

7. The plug-in card of claim 6, wherein the telephone line connector comprises an RJ-11 socket.

8. The plug-in card of claim 2, wherein the plug-in card further comprises:
a bracket; and
an audio connector disposed on the bracket.

9. The plug-in card of claim 3, wherein the plug-in card further comprises:
a bracket; and
a telephone connector disposed on the bracket.

10. The plug-in card of claim 9, wherein the telephone connector comprises an RJ-11 socket.

11. The plug-in card of claim 1, wherein the second edge connector conforms to a specification of a PCI interface.

12. The plug-in card of claim 11, wherein the second circuitry comprises PCI network interface circuitry.

13. A socket for use on a motherboard of a personal computer, the socket receiving a plug-in card to interface the plug-in card to the motherboard, the socket comprising:
an AMR portion, providing serial digital signal lines, the AMR portion conforming to a specification of an Audio/Modem Riser interface; and
a second portion, providing a second set of signal lines.

14. The socket of claim 13, wherein the second set of signal lines provide signals needed for network interface functions.

15. The socket of claim 13, wherein the second portion conforms to a specification of a PCI interface, and wherein the second set of signal lines comprise PCI signal lines.

16. The socket of claim 13, wherein the AMR portion is disposed on the motherboard in a position such that a plug-in card conforming to a specification of an Audio/Modem Riser card may be plugged into the AMR portion.

17. A personal computer system having an audio subsystem, a modem subsystem, the computer system comprising:
a motherboard;
a socket disposed on the motherboard, the socket having an AMR portion that conforms to a specification of an Audio/Modem Riser interface, and a second portion that provides additional signal lines; and
a plug-in card connected to the socket, the plug-in card comprising:
first circuitry, comprising a portion of the circuitry of the modem subsystem;
second circuitry, comprising a portion of the circuitry of the audio subsystem;
network interface circuitry;
an AMR edge connector plugged into the AMR portion of the socket, providing a serial digital signal to the first circuitry and second circuitry, the AMR edge connector conforming to a specification of an Audio/Modem Riser interface; and
a second edge connector plugged into the second portion of the socket, providing signals for use by the network interface circuitry.

18. The personal computer system of claim 17, wherein the first circuitry comprises a modem codec.

19. The personal computer system of claim 17, wherein the second circuitry comprises an audio codec.

20. The personal computer system of claim 17, wherein the second portion of the socket and the second edge connector conform to a specification of a PCI interface, and wherein the network interface circuitry comprises PCI network interface circuitry.
